(19) United States
(12) Patent Application Publication
(10) Pub. No.: US 2004/0203415 A1
(43) Pub. Date: Oct. 14, 2004

(54) Wireless transmission USB hub and method

(76) Inventor: Wen-Jen Wu, Taoyuan (TW)

Correspondence Address: MARTINE & PENILLA, LLP, 710 LAKEWAY DRIVE, SUITE 170, SUNNYVALE, CA, 94085, US

(21) Appl. No.: 10/394,544

(22) Filed: Mar. 21, 2003

(30) Foreign Application Priority Data
Oct. 25, 2002 (TW) 91125373

(51) Int. Cl. H04B 7/00

(52) U.S. Cl. 455/66.1; 455/90.3

(57) ABSTRACT

The invention relates to a wireless transmission universal serial bus (USB) hub and wireless transmission method thereof. The USB hub includes a USB logic hub and a remote hub. The USB logic hub has at least one upstream port to connect with a USB host or a USB hub in order to receive and send a control action from USB host to the remote hub. The remote hob has a plurality of downstream ports each connects with a USB function device or another USB hub. The remote hub detects a connection status of each port and collects information from the USB function device. In addition, the USB logic hub and the remote hub each has an RF modem. The USB logic hub communicates with the remote hub through the RF modem for the USB host to communicate with the USB function device for data transmission.

### BACKGROUND OF INVENTION

1. Field of Invention

The invention relates to a USB hub and its transmission method and, more particularly, to a wireless transmission USB hub and its wireless transmission method.

2. Description of the Related Art

In view of the complications faced when installing and expending conventional computer system and peripherals, a universal serial bus (USB) is a newly proposed bus interface. Under the USB system, all peripherals are able to communicate with the computer host through a single interface, that is, the USB. The feature of the USB is that, all USB function devices have “hot plug” and “plug and play” functions. In other words, when installing or removing a USB device, it is not necessary to turn off the computer host or to install any drivers.

According to the specification of USB, each USB system includes three elements, which are a USB host, a USB inter-connection, and a USB device. In each USB system, there is only one USB host that is normally built inside a computer host. The USB device can be categorized into a USB function device and a USB hub. The USB function device may be the above-mentioned computer peripheral, for example, a keyboard, a mouse, or a printer. Each USB function device is connected to the USB host through the USB inter-connection. Moreover, the USB hub can be expanded from a single port to a plurality of ports so that a plurality of USB function devices can be connected to the USB bus through the hub.

Referring to FIG. 1, a connection of a USB system starts from a USB host 100 and is expanded downward with a star-shape multi-level structure. A root hub 101 is situated at the base of the USB host 100 and has two ports 102 and 103 for connecting a USB function device 105 or a USB hub 104. The USB hub 104 provides a plurality of ports to connect a plurality of USB function devices 105, or another one or more USB hub 106 so as to connect more USB function devices 107. Based on this method, a USB host can be connected to a maximum of 127 USB function devices.

Although using the USB interface transmission has the above-mentioned benefits, there still exists the following limitations and drawbacks. According to the USB specification, only five USB hubs 101, 104, 106, 108, and 110 can be used between the USB host 100 and the USB function devices. Also, cables 120 connecting each device should not exceed the maximum length of five meters. Base on this specification, the distance between the USB host 100 and a furthest USB function device 111 cannot exceed 25 meters. For an office of a larger size, the distance limitation of 25 meters is obviously inadequate.

Besides, if a USB hub is used simply as a signal repeater in order to extend the distance between the USB host and the USB function devices, it incurs a higher cost. In addition, if any one of the connection points is loose, the connection will be broken. Using the USB hubs and cables at the same time to connect the USB host and the USB function devices also reduces the mobility of a portable USB host such as a notebook computer. Therefore, it is an important issue to reduce the cost, overcome the 25-meter distance limitation between the USB host and USB function devices, and to resolve the inconvenience caused by the cable connection between the USB host and USB function devices.

### SUMMARY OF THE INVENTION

In view of the above-mentioned problems, the objective of the invention is to provide a wireless transmission USB hub and a wireless transmission method thereof, in order to solve the specification limitation of 25-meter for the furthest distance between the USB host and the USB function devices.

Another objective of the invention is to provide a wireless transmission USB hub and a wireless transmission method thereof, so that the cost for extending the distance between the USB host and USB function device is decreased.

Still another objective of the invention is to provide a wireless transmission USB hub and a wireless transmission method thereof, which can prevent the unpleasant sight and inconvenience caused when using USB hubs and cables to connect the USB host and USB function devices.

A further objective of the invention is to provide a wireless transmission USB hub and a wireless transmission method thereof, which allows USB function devices with no wireless transmission interface to be connected to the USB host and to send information.

In order to achieve the above-mentioned objectives, the wireless transmission USB hub of the invention includes a USB logic hub and a remote hub. The USB logic hub has at least one upstream port that is connected with a USB host or a USB hub in order to receive and send a control command from the USB host. The remote hub has a plurality of downstream ports each connected with a USB function device or another USB hub. The remote hub detects the connection status of each downstream port, and collects information related to the USB function device. Furthermore, each of the USB logic hub and the remote hub has an RF modem element. The USB logic hub communicates with the remote hub through the RF modem element so that the USB host communicates with the USB function devices for data transmission.

In the wireless transmission method for the wireless transmission USB hub of the invention, firstly, the USB host uses a USB protocol to send a control command to the USB logic hub. The USB logic hub then translates the format of the control command and sends it to the remote hub using a wireless communication protocol. After the remote hub received the control command, it changes the control command back to its original format and executes the command to communicate with a USB function device using a USB protocol. The USB function device generates a response and uses a reverse procedure to send back to the USB host to complete the communication between the USB host and the USB function device.

Under the same condition, the distance for wireless transmission is determined by the wireless transmission technology and its power. Therefore, if the wireless transmission distance between the USB logic hub and the remote hub is greater than 15 meters, using a wireless transmission USB hub of the invention can resolve the specification limitation of 25 meters for the furthest distance between the USB host and the USB function device. In addition, it requires only one wireless transmission USB hub to extend the distance between the USB host and the USB function device. Therefore, it reduces the cost for extending the communication distance. Besides, connecting a computer peripheral with only USB transmission interface to the remote hub allows it to communicate with the USB host via wireless transmission. It is not necessary to have a computer peripheral with wireless transmission interface to enjoy the convenience with wireless transmission.

### BRIEF DESCRIPTION OF THE DRAWINGS

FIG. 1 is a schematic diagram illustrating the connection of a conventional USB system.

FIG. 2A is a schematic diagram illustrating the connection of a USB system with wireless transmission USB hub in accordance with one embodiment of the invention.

FIG. 2B is a schematic diagram illustrating the connection of another USB system with wireless transmission USB hub in accordance with one embodiment of the invention.

FIG. 3 is a schematic diagram illustrating the structure of the wireless transmission USB hub in accordance with one embodiment of the invention.

FIG. 4 is a flow chart illustrating the wireless transmission steps of the wireless transmission hub in accordance with one embodiment of the invention.

### DETAILED DESCRIPTION OF THE PREFERRED EMBODIMENT

A wireless transmission USB hub and its wireless transmission method in accordance with a preferred embodiment of the invention will be described with reference to the accompanying drawings, in which like reference numerals denote like components.

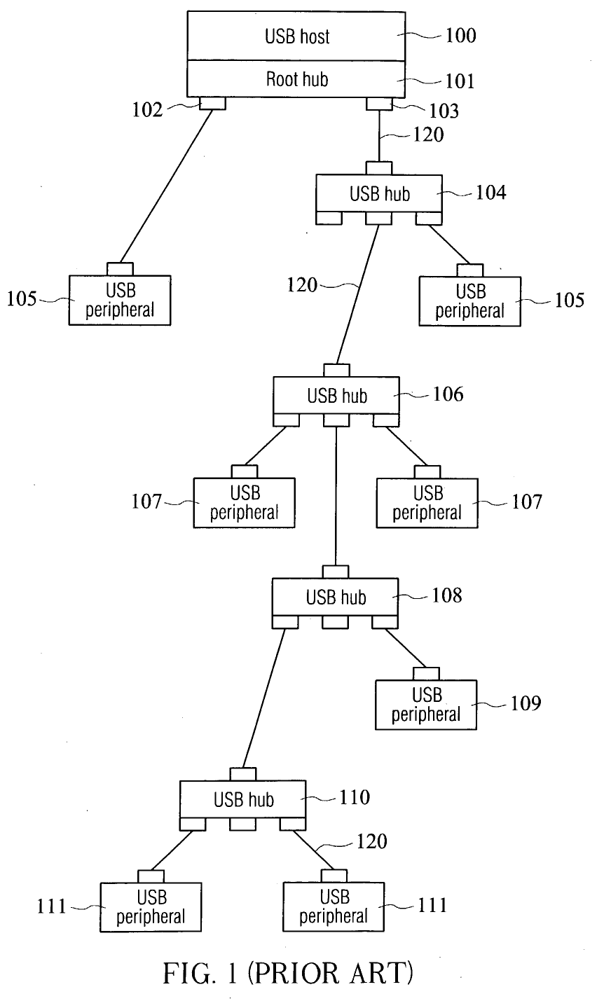

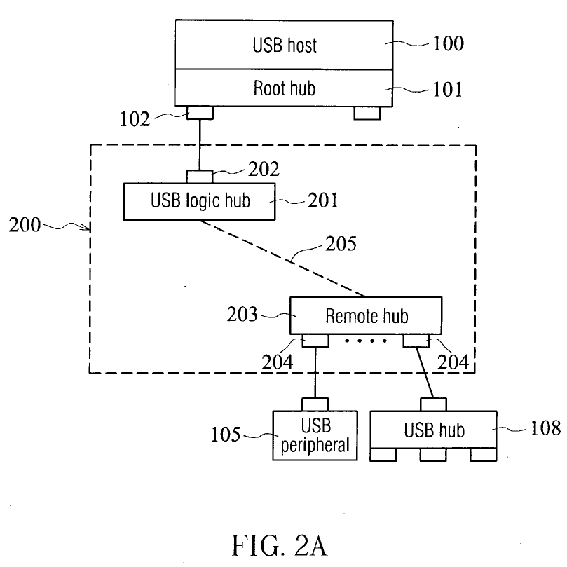

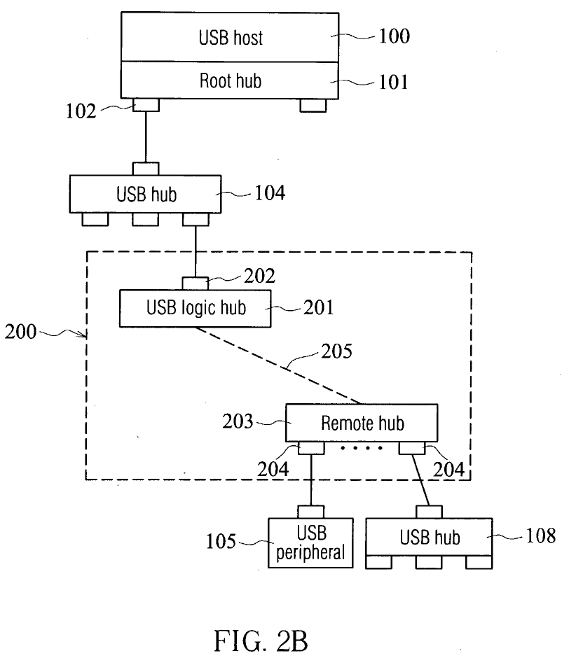

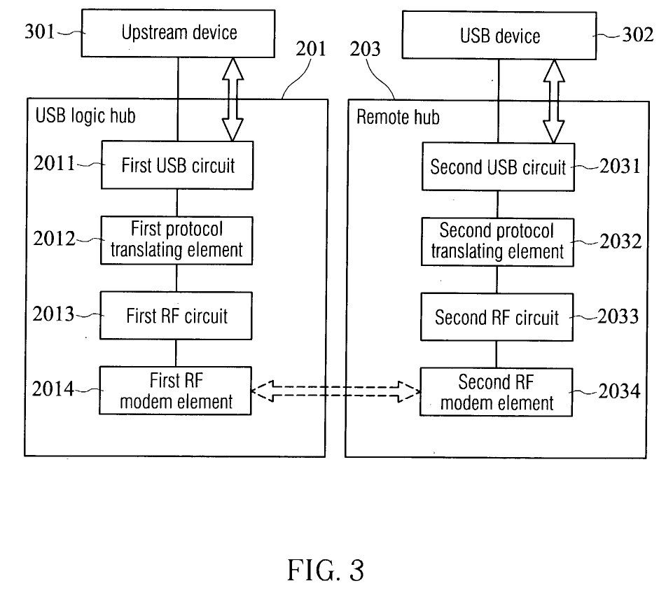

Referring to FIGS. 2A and 2B, a wireless transmission USB hub 200 includes a USB logic hub 201 and a remote hub 203. The USB logic hub 201 includes at least an upstream port 202 to connect with a root hub 101 of a USB host 100 (as shown in FIG. 2A). In this embodiment, the upstream port 202 also can be connected to a USB hub 104 (as shown in FIG. 2B). The USB host 100 and the USB hub 104 will be referred to as an upstream device 301 (as shown in FIG. 3). As shown in FIGS. 2A and 2B, the remote hub 203 includes a plurality of downstream ports 204. Each downstream port 204 can be connected with a USB function device 105 or a USB hub 108. The USB function device 105 and the USB hub 108 will be referred to as a USB device 302 (as shown in FIG. 3). The USB logic hub 201 is connected with the remote hub 203 via wireless transmission 205 to allow information transmission between the upstream device 301 and the USB device 302. The wireless transmission 205 can be a conventional wireless transmission technology. For instance, the bluetooth wireless transmission technology has a transmission distance of 10 meters. Referring to FIG. 1, if the USB hubs 104, 106, 108 and 110 are replaced with the wireless transmission USB hub 200 of the invention, the furthest transmission distance between the USB host 100 and the USB function device 105 will be extended from the conventional 25 meters to the 25 meters plus a total transmission distance of the four wireless transmission USB hubs 200 which is 40 meters. Therefore, the total transmission distance will be added up to 65 meters.

Referring to FIG. 3, the USB logic hub 201 includes a first USB circuit 2011, a first protocol translating element 2012, a first RF circuit 2013 and a first RF modem element 2014. The remote hub 203 includes a second USB circuit 2031, a second protocol translating element 2032, a second RF circuit 2033, and a second RF modem element 2034. The first USB circuit 2011 is used to simulate the USB hub for connecting with an upstream device 301. The second USB circuit 2031 simulates a USB hub for detecting the connection status of a USB device 302. If a USB device 302 is connected, the second USB circuit 2031 collects information from the USB device 302 (e.g. the device is a high-speed device or a low-speed device) and send the information back to the first USB circuit 2011. The first USB circuit 2011 then represents the USB device 302 to communicate with the upstream device 301.

The communication between the first USB circuit 2011 and the second USB circuit 2031 is by means of wireless transmission. Taking the example of the second USB circuit 2031 detecting the connection status of the USB device 302, the second USB circuit 2031 uses data which complies with the format of USB protocol to communicate with the USB device 302, collects the connection status and information from the USB device 302. The USB format data are translated by the second protocol translating element 2032 into a data format that complies with the format of RF protocol. Taking the example of bluetooth wireless transmission technology, the RF protocol format data means the bluetooth format data. After being processed by the second RF circuit 2033, the data are broadcasted by the second RF modem element 2034. After the first RF modem element 2014 receives the data, the data are then processed by the first RF circuit 2013, and then translated back to the USB format by the first protocol translating element 2012. Finally, through the first USB circuit 2011, the data are sent to the upstream device 301 to communicate with the USB host 100. On the other hand, the USB host 100 sends a control command in USB data format to communicate with the first USB circuit 2011. After the data being translated into the bluetooth format by the first protocol translating element 2012 and processed by the first circuit 2013, the data are broadcasted by the first RF modem element 2014. After the data being received by the second RF modem element 2034, processed by the second RF circuit 2033, and translated back to USB format by the second protocol translating element 2032, the second USB circuit 2031 then executes the control command and communicates with the USB device 302.

In addition, the second USB circuit 2031 can further schedule for a plurality of USB transactions in order to comply with the specification that the USB host 100 can only communicate with one USB function device 105 at one time. The first USB circuit 201 also has the function for detecting transmission errors, such as checking the cyclic redundancy check code for sending data.

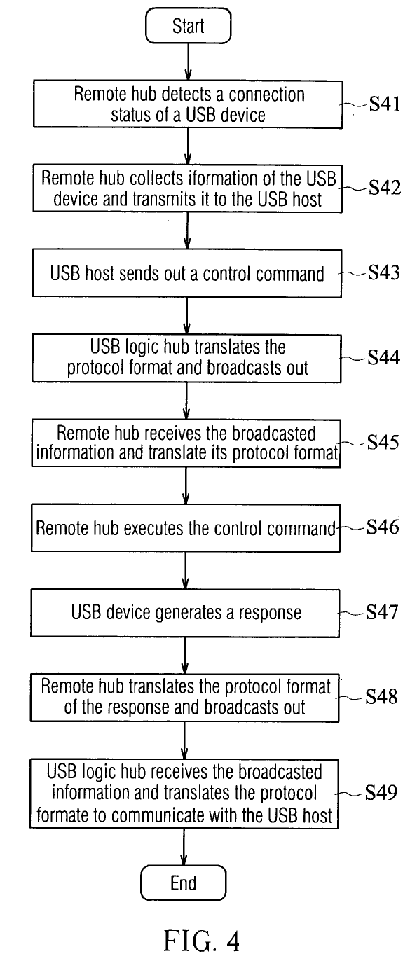

The wireless transmission method of the wireless transmission USB hub in accordance with the embodiment will be described below. Referring to FIG. 4, the remote hub 203 detects a connection status of a USB device 302 (S41). If there is a USB device 302 connected to the remote hub 203, the remote hub 203 then collects information from the USB device 302 and sends it to the USB host 100 (S42). The transmission method is as those described above and will not be described again here. After the USB device 302 completes the connection, the USB host 100 sends out a control command (S43), which communicates with the USB logic hub 201 using the USB protocol. The USB logic hub 201 translates the control command into a wireless communication protocol format and broadcasts it (S44). The remote hub 203 receives the control command, translates it back to the USB protocol format (S45), and executes the control command to communicate with the USB device 302 (S46). The USB device 302 generates a suitable response based on this control command and sends it back to the remote hub using the USB protocol (S47). The response is translated into a wireless communication protocol format by the remote hub 203, and then the response is broadcasted out (S48). Finally, the USB logic hub 201 receives the response and translates it back to the USB protocol format to communicate with the USB host 100 (S49). Thus completes the communication between the USB host 100 and the USB device 302.

According to the invention, the furthest distance between the USB host and the USB function device is the cable connection distance of 25 meters plus the wireless transmission distance of the embodiment, which resolves the limitation of 25 meters for the furthest connection distance. Taking the bluetooth wireless technology as an example, the distance between the USB host and the USB function device can be extended to 65 meters. It should be noted that the effective distance for wireless transmission depends on the wireless transmission technology used and its power. Therefore, if another kind of wireless transmission technology is used to increase the transmission distance between the USB logic hub and the remote hub to greater then 15 meters, plus the cable length of 10 meters at each end, it can use a wireless transmission USB hub to extend the distance between the USB host and the USB function device, overcome the specification limitation of 25 meters, save the cost for the other three USB hubs, prevent the problem of cable connection, and increase the mobility of the portable USB host. At the meantime, connecting a computer peripheral with only a USB transmission interface to the remote hub with the wireless transmission USB hub will have the convenience of wireless transmission. It is no longer necessary to purchase an expensive computer peripheral with a wireless transmission interface.

While the invention has been particularly described, in conjunction with a specific embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the invention.

What is claimed is:

1. A wireless transmission universal serial bus (USB) hub for connecting an upstream device and a USB device so that the upstream device can communicate with the USB device, the wireless transmission USB hub comprising:
a USB logic hub having at least one upstream port to connect with the upstream device and a first radio frequency (RF) modem element to communicate wirelessly with a corresponding RF modem element, wherein the USB logic hub simulates a USB hub in order to receive and send a control command of a USB host; and
a remote hub having a plurality of downstream ports each connected with the USB device, and a second RF modem element to communicate wirelessly with the first RF modem element of the USB logic hub, wherein the remote hub detects a connection status of the downstream ports with the USB device and uses the second RF modem element to send the connection status to the USB logic hub.

2. The wireless transmission USB hub of claim 1, wherein the USB logic hub further receives the connection status of the downstream ports from the remote hub, and uses a USB protocol to send the connection status to the upstream device.

3. The wireless transmission USB hub of claim 1, wherein the USB logic hub further provides a transmission error detection function.

4. The wireless transmission USB hub of claim 1, wherein the remote hub further collects device information of the USB device connected to the downstream ports, and uses the second RF modem device to send the device information to the USB logic hub.

5. The wireless transmission USB hub of claim 1, wherein the remote hub further executes the control command of the USB host to the USB device.

6. The wireless transmission USB hub of claim 1, wherein the USB logic hub further includes:
a first USB circuit for simulating the USB hub and replacing the USB device to communicate with the upstream device using a USB protocol;
a first protocol translating element for translating USB protocol format data from the upstream device into RF protocol format data, or translating RF protocol format data from the USB device into USB protocol format data; and
a first RF circuit for receiving the RF protocol format data from the first USB circuit and sending the RF protocol format data to the remote hub through the first RF modem element, or receiving a responses from the remote hub and sending the response to the first USB circuit.

7. The wireless transmission USB hub of claim 1, wherein the remote hub further includes:
a second USB circuit for detecting the connection status of the USB device, and using a USB protocol to communicate with the USB device;
a second protocol translating element for translating RF protocol format data from the upstream device into USB protocol format data, or translating USB protocol format data from the USB device into RF protocol format data; and
a second RF circuit for receiving the control command of the USB logic hub and sending the control command to the second USB circuit, or receiving the RF protocol format data from the second USB circuit and, sending the RF protocol format data to the USB logic hub through the second RF modem element.

8. The wireless transmission USB hub of claim 7, wherein the second USB circuit can further schedule for a plurality of USB transactions.

9. A wireless transmission method of universal serial bus (USB) hub comprising the steps of:
a USB host sending out a USB protocol format control command;
a USB logic hub translating the USB protocol format control command into an RF protocol format control command and broadcasting it;
a remote hub receiving the RF protocol format control command and translating it into the USB protocol format control command;
the remote hub executing the control command to communicate with a USB device;
the USB device generating a response in accordance with the USB protocol format control command;
the remote hub translating the response from a USB protocol format into an RF protocol format and broadcasting it; and
the USB logic hub receiving the response and translating it from the RF protocol format into a USB protocol format to communicate with the USB host.

10. The wireless transmission method of claim 9, further comprising the step of:
the remote hub detecting a connection status of the USB device.

11. The wireless transmission method of claim 10, further comprising the step of:
sending information of the USB device back to the USB host if the USB device is connected to the remote hub.

12. A USB logic hub used in conjunction with a remote hub to connect an upstream device and a USB device for sending information wirelessly, the remote hub having a second RF modem element and a plurality of downstream ports, the second RF modem element being connected to the USB logic hub via wireless transmission, the downstream port being connected to the USB device, the USB logic hub comprising:
a first RF modem element connected to the remote hub via wireless transmission for data exchanging; and
at least one upstream port connected with the upstream device to receive and send a control command of a USB host.

13. The USB logic hub of claim 12, wherein the logic hub further includes:
a first USB circuit for simulating the USB hub, and replacing the USB device to communicate with the upstream device using a USB protocol;
a first protocol translating element for translating USB protocol format data from the upstream device into RF protocol format data, or translating RF protocol format data from the USB device into USB protocol format data; and
a first RF circuit for receiving the RF protocol format data from the first USB circuit and sending the RF protocol format data to the remote hub through the first RF modem element, or receiving responses from the remote hub and sending the responses to the first USB circuit.

14. A remote hub used in conjunction with a USB logic hub to connect a upstream device and a USB device for sending information wirelessly, the USB logic hub having a first RF modem element and at least one upstream ports, the first RF modem element being connected to the remote hub via wireless transmission, the upstream port being connected to the upstream device, the remote hub comprising:
a second RF modem element connected to the USB logic hub via wireless transmission for data exchanging; and
a plurality of downstream ports connected with the USB device to receive and send a control command of a USB host.

15. The remote hub of claim 14, the remote hub further includes:
a second USB circuit for detecting a connection status of the USB device, and communicating with the USB device using a USB protocol;
a second protocol translating element for translating RF protocol format data from the upstream device into USB protocol format data, or translating USB protocol format data from the USB device into RF protocol format data; and
a second RF circuit for receiving the control command from the USB logic hub and sends the control command to the second USB circuit, or receiving the RF protocol format data from the second USB circuit and sending the RF protocol format data to the USB logic hub through the second RF modem element.

16. The remote hub of claim 15, wherein the second USB circuit can further schedule for a plurality of USB transactions.
